(19) United States
(12) Patent Application Publication
(10) Pub. No.: US 2009/0086811 A1
(43) Pub. Date: Apr. 2, 2009

(54) VIDEO ENCODING SYSTEM AND WATERMARKING MODULE FOR TRANSMARKING A VIDEO SIGNAL AND METHOD FOR USE THEREWITH

(76) Inventor: Paul Ducharme, Scarborough (CA)

Correspondence Address: GARLICK HARRISON & MARKISON, P.O. BOX 160727, AUSTIN, TX, 78716-0727, US

(21) Appl. No.: 11/864,630

(22) Filed: Sep. 28, 2007

(51) Int. Cl. H04N 11/02

(52) U.S. Cl. 375/240.01

(57) ABSTRACT

A watermarking module can be used in a video encoding system that processes a video signal. A watermark recovery module generates recovered watermark data based on watermark data from the video signal. A watermark generation module generates a watermarked video signal in accordance with the recovered watermark data.

### CROSS REFERENCE TO RELATED PATENTS

The present application is related to the co-pending application, VIDEO ENCODING SYSTEM AND WATERMARKING MODULE FOR WATERMARKING A VIDEO SIGNAL AND METHOD FOR USE THEREWITH, having Ser. No. ______, and filing date ______, the contents of which is incorporated herein by reference thereto.

### TECHNICAL FIELD OF THE INVENTION

The present invention relates to watermarking of media signals such as video signals.

### DESCRIPTION OF RELATED ART

Certain multimedia content, such as music compact disks (CDs), video cassettes digital video disks (DVDs), digital video files and digital images include copy protection signals that are meant to prevent or discourage the multimedia content contained on these media from being copied or to track the origin of copyrighted material. Examples of such techniques are macrovision protection, dongle protection mechanisms and digital watermarking, a mechanism to add hidden copyright notices to digital audio, video, or image signals and other multimedia content. The digital watermark can be a signal that describes information pertaining to the multimedia content or to the author of the content (name, place, etc.) so that protected works can be identified. The technique takes its name from the watermarking used in the printing industry to identify the manufacturer or originator of paper used in documents, to prevent against counterfeiting in the production of currency, etc. Digital watermarking is a special case of steganography, a broad category of hidden writing used to embed messages documents or images that are difficult to detect.

Copy protection mechanisms can provide challenges to the compression and encoding techniques used when this content is transmitted or stored. In many such circumstances, the copy protection must be disabled for transmission between devices. In addition, WLAN signals can be encrypted to prevent unauthorized access to the WLAN and to prevent access unauthorized access to program content and/or other information that is transmitted over the WLAN. Encrypted signals can also be used for other secure communication and secure access applications.

The limitations and disadvantages of conventional and traditional approaches will become apparent to one of ordinary skill in the art through comparison of such systems with the present invention.

### BRIEF DESCRIPTION OF THE SEVERAL VIEWS OF THE DRAWINGS

FIG. 1 presents a block diagram representation of a video processing system 150 in accordance with an embodiment of the present invention.

FIG. 2 presents a pictorial representation of example host devices 11-16 in accordance with an embodiment of the present invention.

FIG. 3 presents a block diagram representation of a watermarking module 125 in accordance with an embodiment of the present invention.

FIG. 4 presents a block diagram representation of a video encoding system 102 in accordance with an embodiment of the present invention.

FIG. 5 presents a block diagram representation of a video distribution system 175 in accordance with an embodiment of the present invention.

FIG. 6 presents a block diagram representation of a video storage system 179 in accordance with an embodiment of the present invention.

FIG. 7 presents a flowchart representation of a method used in watermarking a signal in accordance with an embodiment of the present invention.

FIG. 8 presents a flowchart representation of a method used in watermarking a signal in accordance with an embodiment of the present invention.

FIG. 9 presents a flowchart representation of a method used in watermarking a signal in accordance with an embodiment of the present invention.

FIG. 10 presents a flowchart representation of a method used in watermarking a signal in accordance with an embodiment of the present invention.

FIG. 11 presents a flowchart representation of a method used in watermarking a signal in accordance with an embodiment of the present invention.

FIG. 12 presents a flowchart representation of a method used in watermarking a signal in accordance with an embodiment of the present invention.

FIG. 13 presents a flowchart representation of a method used in watermarking a signal in accordance with an embodiment of the present invention.

FIG. 14 presents a flowchart representation of a method used in watermarking a signal in accordance with an embodiment of the present invention.

FIG. 15 presents a flowchart representation of a method used in watermarking a signal in accordance with an embodiment of the present invention.

### DETAILED DESCRIPTION OF THE INVENTION INCLUDING THE PRESENTLY PREFERRED EMBODIMENTS

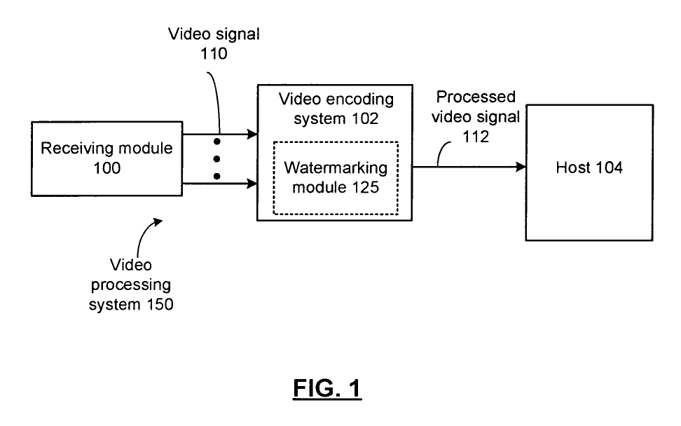

FIG. 1 presents a block diagram representation of a video processing system 150 in accordance with an embodiment of the present invention. In particular, video processing system 150 includes a receiving module 100, such as a set-top box, television receiver, personal computer, cable television receiver, satellite broadcast receiver, broadband modem, 3G transceiver or other information receiver or transceiver that is capable of receiving video signals 110 from one or more sources such as a broadcast cable system, IP television network, a broadcast satellite system, the Internet, a digital video disc player, a digital video recorder, or other video source.

Video encoding system 102 is coupled to the receiving module 100 to encode, one or more of the video signals 110 to form processed video signal 112 that are transferred to a host 104 that plays, processes, stores, distributes or otherwise operates based on the processed video signal 112. This encoding can include transcoding, including transrating and transcaling, in addition, the encoding can include encrypting or transcrypting, and watermarking or transmarking.

In an embodiment of the present invention, the video signals 110 can include a broadcast video signal, such as a television signal, high definition television signal, enhanced high definition television signal or other broadcast video signal that has been transmitted over a wireless medium, either directly or through one or more satellites or other relay stations or through a cable network, optical network or other transmission network. In addition, the video signals 110 can be generated from a stored video file, played back from a recording medium such as a magnetic tape, magnetic disk or optical disk, and can include a streaming video signal that is transmitted over a public or private network such as a local area network, wide area network, metropolitan area network or the Internet.

Video signal 110 can include an analog video signal that is formatted in any of a number of video formats including National Television Systems Committee (NTSC), Phase Alternating Line (PAL) or Sequentiel Couleur Avec Memoire (SECAM). Processed video signal includes 112 a digital video codec standard such as H.264, MPEG-4 Part 10 Advanced Video Coding (AVC) or other digital format such as a Moving Picture Experts Group (MPEG) format (such as MPEG1, MPEG2 or MPEG4), Quicktime format, Real Media format, Windows Media Video (WMV) or Audio Video Interleave (AVI), or another digital video format, either standard or proprietary that may or may not include a related audio signal.

The video encoding system 102 includes a watermarking module 125 that operates to include a watermark in the processed video signal 112 as will be described in greater detail in conjunction with the figures that follow.

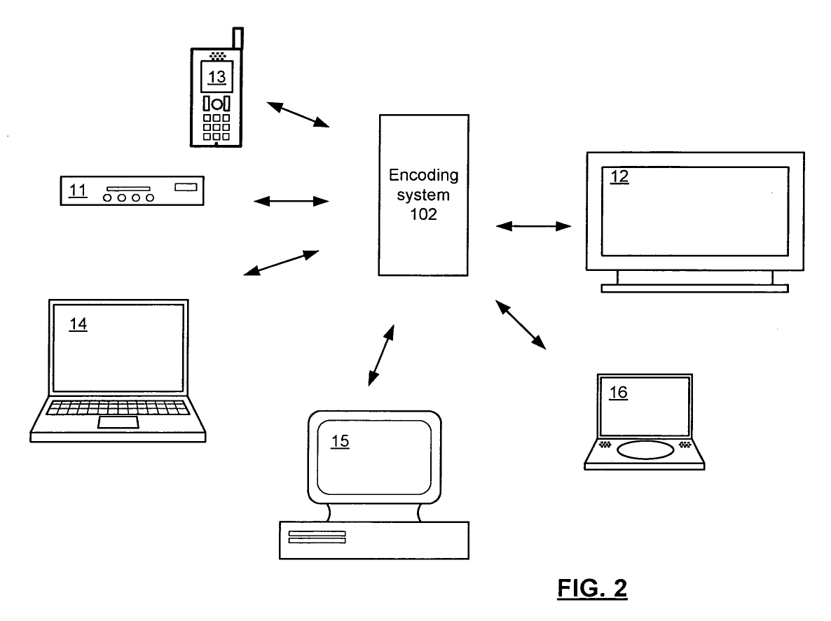

FIG. 2 presents a pictorial representation of example host devices 11-16 in accordance with an embodiment of the present invention. In particular, examples of host device 104 include digital video recorder/set top box 11, television or monitor 12, wireless telephony device 13, computers 14 and 15, personal video player 16, or other host devices that process video signals such as processed video signal 112. Video encoding system 102 is coupleable to one or more of these host devices via a host interface. Video encoding system 102 can take on any one of a number of form factors such as a PC card, memory card, personal computer memory card international association (PCMCIA) card, universal serial bus (USB) dongle, or other device that is coupleable to one or more host devices via an Ethernet connection, a memory card interface, USB connection, Firewire (IEEE 1394) connection, small computer system interface (SCSI), PCMCIA interface, or other interface either standard or proprietary. In the alternative, video encoding system 102 can be incorporated directly into the host device.

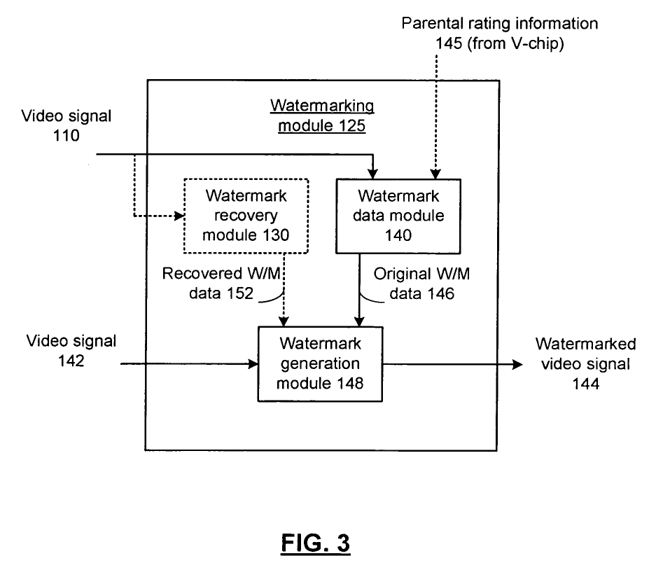

FIG. 3 presents a block diagram representation of a watermarking module 125 in accordance with an embodiment of the present invention. In particular, watermarking module 125 includes a watermark data module 140 that can generate original watermark data 146 that is based on non-watermark data generated from information the video signal 110. A watermark generation module 148 generates a watermarked video signal 144 in accordance with the original watermark data 146 by applying a digital watermark to the video signal 142.

In operation, the video signal 110 can be an analog video signal that is optionally encoded, including optional scale to resolution and/or encrypted by video encoding system 102. In this instance, the video signal 142 can be the encoded version of video signal 110. In the alternative, the video signal 110 can be a digital video signal that is optionally transcoded, including transcaling to a different resolution, transrating to a different data rate and/or encrypted via an encryption technique, either public key or otherwise or transcrypted (if the video signal 110 was also encrypted) by video encoding system 102. In this instance, the video signal 142 can be the encoded version of video signal 110. Further, without encoding, the video signal 142 can simply be the original video signal 110.

Watermark generation module 148 can operate to add a watermark signal to video signal 142, to change the least significant bit or bits of the pixels within the video signal 142 or to apply other steganographic techniques to conceal the original watermark data 146 in the watermarked video signal 144. In this fashion, when the watermarked video signal 144 is decoded, the original watermark data 146 can be recovered and/or used for digital rights management, or for other purposes associated with the particular data that is included in the original watermark data 146.

In an embodiment of the present invention, the non-watermark data used to generate the original watermark data 146 can include content control information (CCI) associated with the content of video signal 110 that is retrieved from the video blanking interval (VBI) of video signal 110 or from the digital source (if video signal 110 is a digital video signal). In this way, a decoder that receives the watermarked video signal 144 could decode the watermark and enforce the CCI at the receiver to protect the content of video signal 110 from unauthorized use, viewing, transmittal, storage, etc. This has the advantage that a hacker could not easily remove the original watermark data 146 from the watermarked video signal 144 based on the concealed nature of the data.

Further, the non-watermark data can include parental rating information recovered from either a video blanking interval of the video signal 110 and digital data included in the video signal 110 or parental rating information 145 received from a V-chip that is included in video encoding system 102. In this way, a decoder that receives the watermarked video signal 144 could decode the watermark and enforce the parental rating information at the receiver to protect the content of video signal 110 from unauthorized viewing by underage viewers, etc.

In addition, the non-watermark data can include closed captioning information recovered from either a video blanking interval of the video signal and digital data included in the video signal 110. In this way, a decoder that receives the watermarked video signal 144 could decode the watermark to recover the close captioning information for optional display in conjunction with the content of video signal 110.

In another mode of operation where the watermarked video signal 144 is encrypted or otherwise scrambled by the video encoding system 102, the watermark data module 140 can generate original watermark data that includes a codeword associated with scrambling/encrypting of the video content or other content of the video signal 110. In this fashion, the codeword, such as an encryption key or other descrambling codeword can be incorporated into the digital watermark. For example, the watermarked video signal 144 can be a video stream that is segmented into portions, such as crypto-cycles, that are encrypted with unique encryption keys. The encryption key for a particular crypto-cycle can be incorporated in the digital watermark of the prior crypto-cycle, so that when the watermark is decoded, it can be used to decrypt the content in the next crypto-cycle. This has the advantage that tampering with the digital watermark signal, for instance in an attempt to foil the CCI or parental controls, could destroy the encryption key or other codeword required to recover the content.

While the forgoing description contemplates watermarking based on original watermark data 146 that is formed from non-watermark data. Watermarking module 125 can also operate to generate watermarked video signal 144 based on recovered watermark data 152 that is extracted from a watermark in video signal 110. For example, video signal 110 can include a watermark that could otherwise be corrupted in the optional encoding, transcoding, transcaling, transrating, and/or transcypting performaed by video encoding system 102. In this embodiment, watermark recovery module 130 extracts the watermark information from video signal 110 and generates the recovered watermark data 152 in response. Watermark generation module then re-watermarks or “transmarks” the recovered watermark data 152 in the watermark of watermarked video signal 144, either alone, or in combination with one or more instances of original watermark data 146 that have been previously discussed. Besides reconstituting the recovered watermark data 152 in the new watermark, this allows the recovered watermark data 152 to optionally be combined with original watermark data such as parental control information, etc.

FIG. 4 presents a block diagram representation of a video encoding system 102 in accordance with an embodiment of the present invention. In particular, video encoding system 102 operates in accordance with many of the functions and features of the H.264 standard, the MPEG-4 standard, VC-1 (SMPTE standard 421M) or other standard, to encode, transrate, transcale, and/or transcode video input signals 110 that are received via a signal interface 198. In addition or in the alternative, video encoding system 102 operates to decrypt, and optionally encode, transcode, transrate, transcale the video signal 110 and then reencrypt (“transcrypt”) the video signal 110 to produce a processed video signal 112 that is transcrypted and optionally transcoded, transcaled, transrated, into an altered format and is transferred to a host device via signal interface 198 in conjunction with an optional host protocol.

The video encoding system 102 includes a signal interface 198, processing module 230, memory module 232, encoding module 234, watermarking module 125, and optional decoding module 236, encrypting module 238, decrypting module 240, and V-chip circuit 242. The processing module 230 that can be implemented using a single processing device or a plurality of processing devices. Such a processing device may be a microprocessor, co-processors, a micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in a memory, such as memory module 232. Memory module 232 may be a single memory device or a plurality of memory devices. Such a memory device can include a hard disk drive or other disk drive, read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

Processing module 230, and memory module 232 are coupled, via bus 250, to the signal interface 198 and a plurality of other modules. The modules of video encoder 102 can be implemented in software, firmware or hardware, depending on the particular implementation of processing module 230. It should also be noted that the software implementations of the present invention can be stored on a tangible storage medium such as a magnetic or optical disk, read-only memory or random access memory and also be produced as an article of manufacture. While a particular bus architecture is shown, alternative architectures using direct connectivity between one or more modules and/or additional buses can likewise be implemented in accordance with the present invention.

In operation, encoding module 234 operates to produce an encoded or transcoded video stream based on either video signal 110 or based on a decoded and/or decrypted version of video signal 110 as processed by decoding module 236 and/or decrypting module 240. The processed video signal 112, such as watermarked video signal 144, is watermarked or transmarked by watermarking module 125, and optionally encrypted or re-encrypted by encryption module 238. V-chip circuit 242 generates parental control information such as parental control information 145 that can also be incorpoated in the new watermark.

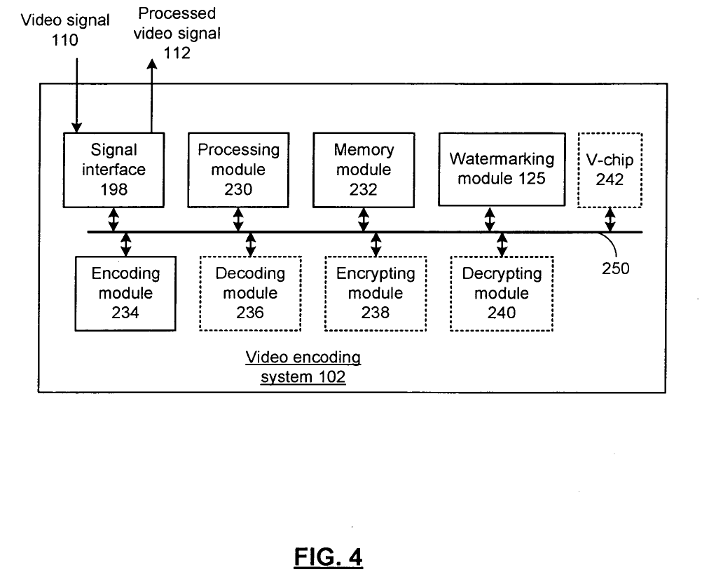

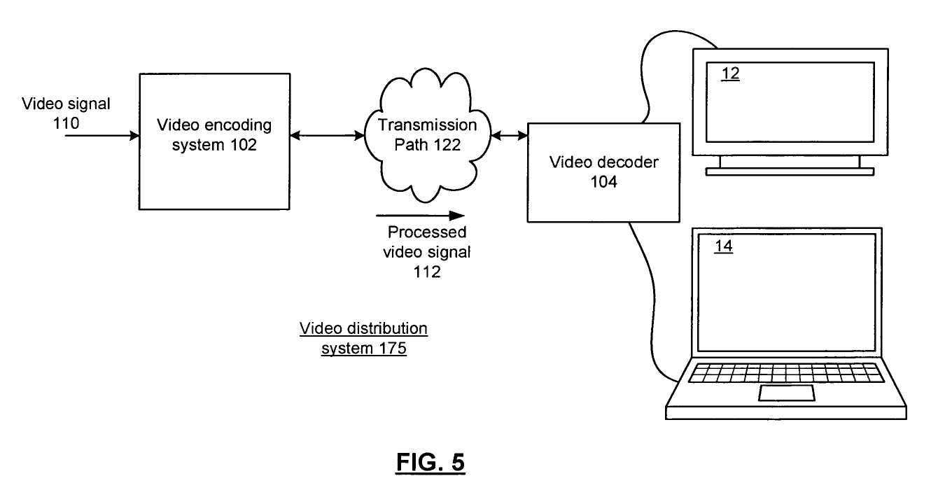

FIG. 5 presents a block diagram representation of a video distribution system 175 in accordance with an embodiment of the present invention. In particular, processed video signal 112 is transmitted via a transmission path 122 to a video decoder 104. Video decoder 104, in turn can operate to decrypt and decode the processed video signal for display on a display device such as television 12, computer 14 or other display device.

The transmission path 122 can include a wireless path that operates in accordance with a wireless local area network protocol such as an 802.11 protocol, a WIMAX protocol, a Bluetooth protocol, etc. Further, the transmission path can include a wired path that operates in accordance with a wired protocol such as a USB protocol, high-definition multimedia interface (HDMI) protocol an Ethernet protocol or other high speed protocol.

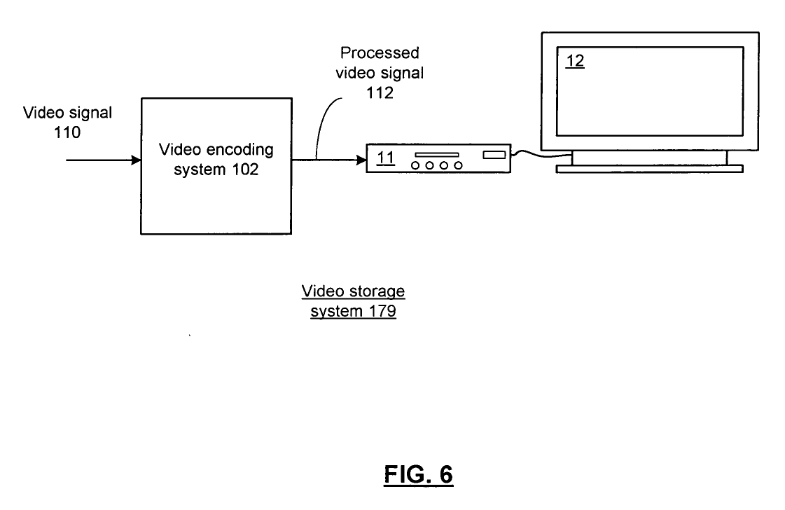

FIG. 6 presents a block diagram representation of a video storage system 179 in accordance with an embodiment of the present invention. In particular, device 11 is a set top box with built-in digital video recorder functionality, a stand alone digital video recorder, a DVD recorder/player or other device that decrypts and stores the processed video signal 112 for display on video display device such as television 12. While video encoder 102 is shown as a separate device, it can further be incorporated into device 11. While these particular devices are illustrated, video storage system 179 can include a hard drive, flash memory device, computer, DVD burner, or any other device that is capable of generating, storing, decoding and/or displaying the content of processed video stream 112 in accordance with the methods and systems described in conjunction with the features and functions of the present invention as described herein.

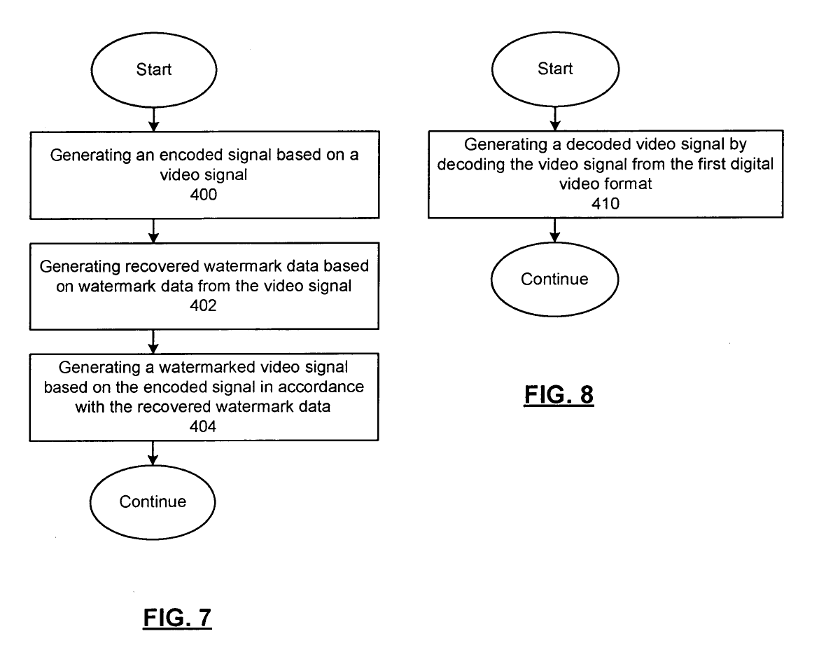

FIG. 7 presents a flowchart representation of a method in accordance with an embodiment of the present invention. In particular a method is presented for use in conjunction with one or more functions and features described in conjunction with FIGS. 1-6. In step 400, an encoded video signal is generated based on a video signal. In step 402, recovered watermark data is generated based on watermark data from the video signal. In step 404, a watermarked video signal is generated based on the encoded video signal in accordance with the recovered watermark data.

FIG. 8 presents a flowchart representation of a method in accordance with an embodiment of the present invention. In particular a method is presented for use in conjunction with one or more functions and features described in conjunction with FIG. 7, wherein the video signal includes a digital video signal in a first digital video format. In step 410, a decoded video signal is generated by decoding the video signal from the first digital video format wherein, step 400 generates the encoded video signal in a second digital video format from the decoded video signal of step 410. In an embodiment of the present invention, the second digital video format is transcaled and/or transrated from the first digital video format.

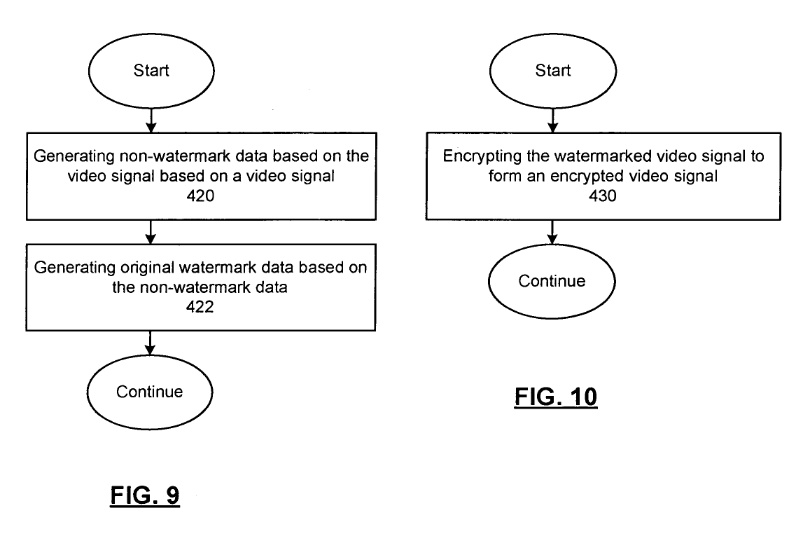

FIG. 9 presents a flowchart representation of a method in accordance with an embodiment of the present invention. In particular a method is presented for use in conjunction with one or more functions and features described in conjunction with FIGS. 7 & 8. In step 420, non-watermark data is generated based on the video signal. In step 422, original watermark is generated data based on the non-watermark data, wherein step 404 generates the watermarked video signal in accordance with both the original watermark data and recovered watermark data.

In an embodiment of the present invention, the non-watermark data includes content control information recovered from one of, a video blanking interval of the video signal and digital data included in the video signal. The non-watermark data can include parental rating information recovered from one of, a video blanking interval of the video signal and digital data included in the video signal or parental rating information received from a V-chip generated in response to the video signal. The non-watermark data can include closed captioning information recovered from one of, a video blanking interval of the video signal and digital data included in the video signal. The original watermark data can include a codeword used to decrypt or otherwise descramble the watermarked video.

FIG. 10 presents a flowchart representation of a method in accordance with an embodiment of the present invention. In particular a method is presented for use in conjunction with one or more functions and features described in conjunction with FIGS. 7-9 wherein the original watermark data includes a codeword. In step 430, the watermarked video signal is encrypted to form an encrypted video signal, wherein the codeword includes a decryption key for decrypting a portion of encrypted video signal.

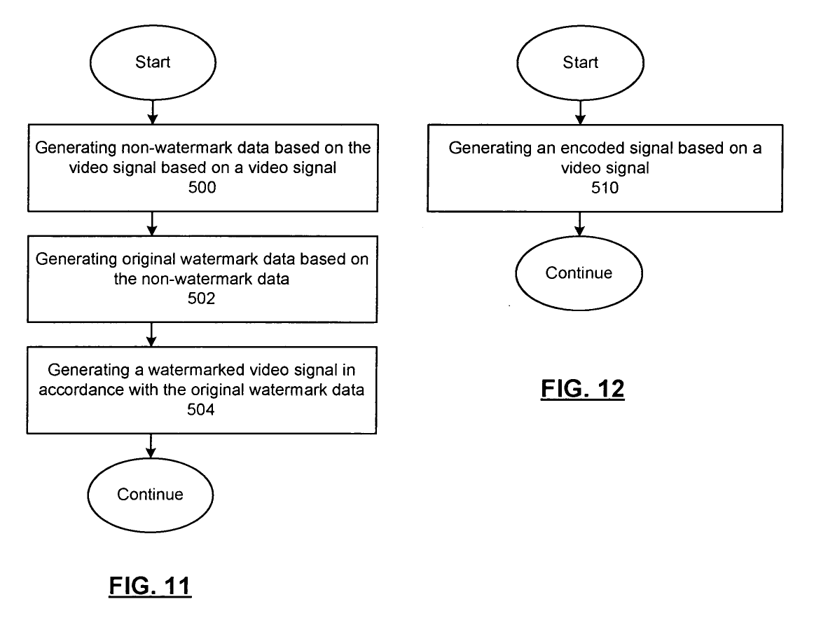

FIG. 11 presents a flowchart representation of a method in accordance with an embodiment of the present invention. In particular a method is presented for use in conjunction with one or more functions and features described in conjunction with FIGS. 1-6. In step 500, non-watermark data is generated based on the video signal. In step 502, original watermark data is generated based on the non-watermark. In step 504, a watermarked video signal is generated in accordance with the original watermark data.

In an embodiment of the present invention, the non-watermark data includes content control information recovered from one of, a video blanking interval of the video signal and digital data included in the video signal. The non-watermark data can include parental rating information recovered from one of, a video blanking interval of the video signal and digital data included in the video signal or parental rating information received from a V-chip in response to the video signal. The non-watermark data can also include closed captioning information recovered from one of, a video blanking interval of the video signal and digital data included in the video signal.

FIG. 12 presents a flowchart representation of a method in accordance with an embodiment of the present invention. In particular a method is presented for use in conjunction with one or more functions and features described in conjunction with FIG. 11. In step 510, an encoded video signal is generated based on a video signal, wherein the step of generating a watermarked video signal is based on the encoded video signal.

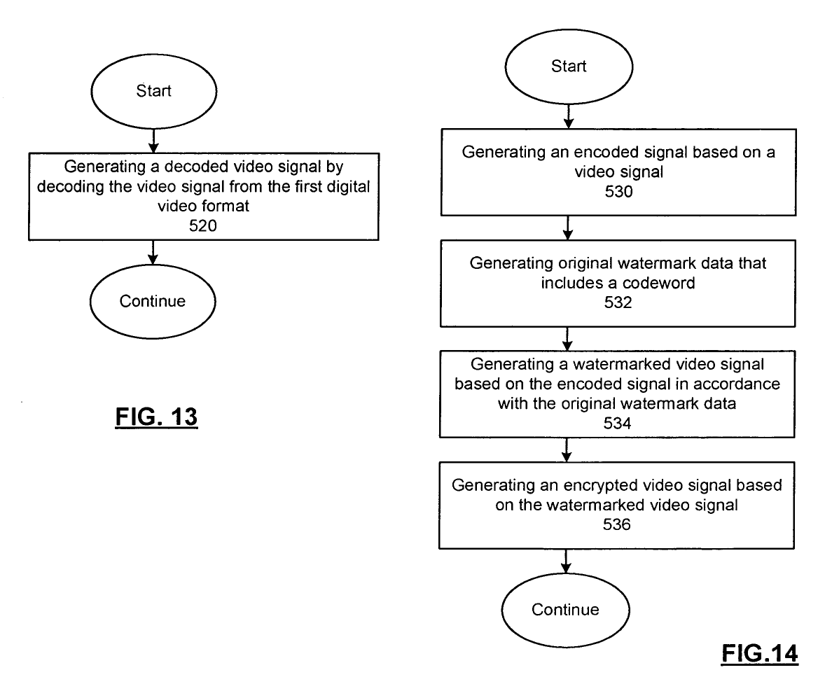

FIG. 13 presents a flowchart representation of a method in accordance with an embodiment of the present invention. In particular a method is presented for use in conjunction with one or more functions and features described in conjunction with FIGS. 11-12. In step 520, a decoded video signal is generated by decoding the video signal from the first digital video format, step 510 generates the encoded video signal in a second digital video format from the decoded video signal. In an embodiment of the present invention, the second digital video format is transcaled and/or transrated from the first digital video format.

FIG. 14 presents a flowchart representation of a method in accordance with an embodiment of the present invention. In particular a method is presented for use in conjunction with one or more functions and features described in conjunction with FIGS. 1-6. In step 530, an encoded video signal is generated based on the decrypted video signal. In step 532, original watermark data is generated that includes a codeword. In step 534, a watermarked video signal is generated based on an encoded video signal and in accordance with the original watermark data. In step 536, an encrypted video signal is generated based on the watermarked video signal. In an embodiment of the present invention, the codeword includes a decryption key for decrypting a portion of encrypted video signal.

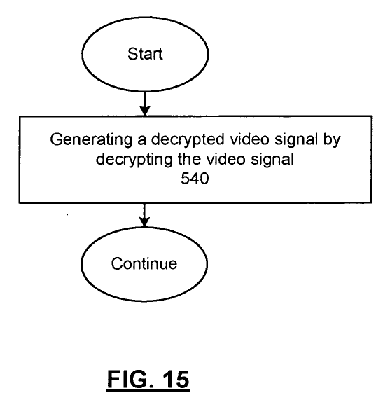

FIG. 15 presents a flowchart representation of a method in accordance with an embodiment of the present invention. In particular a method is presented for use in conjunction with one or more functions and features described in conjunction with FIG. 14. In particular, when the video signal is encrypted, the method includes step 540 of generating a decrypted video signal by decrypting the video signal.

As used herein, the term video signal includes video signals, with or without accompanying audio signals.

While particular combinations of various functions and features of the present invention have been expressly described herein, other combinations of these features and functions are possible that are not limited by the particular examples disclosed herein are expressly incorporated in within the scope of the present invention.

As one of ordinary skill in the art will appreciate, the term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “coupled”.

As the term module is used in the description of the various embodiments of the present invention, a module includes a functional block that is implemented in hardware, software, and/or firmware that performs one or more functions such as the processing of an input signal to produce an output signal. As used herein, a module may contain submodules that themselves are modules.

Thus, there has been described herein an apparatus and method, as well as several embodiments including a preferred embodiment, for implementing video processing and video storage systems and watermarking module for use therewith and with other processing systems. Various embodiments of the present invention herein-described have features that distinguish the present invention from the prior art.

It will be apparent to those skilled in the art that the disclosed invention may be modified in numerous ways and may assume many embodiments other than the preferred forms specifically set out and described above. Accordingly, it is intended by the appended claims to cover all modifications of the invention which fall within the true spirit and scope of the invention.

What is claimed is:

1. A watermarking module for use in a video encoding system that processes a video signal, the watermarking module comprising:
a watermark recovery module that generates recovered watermark data based on watermark data from the video signal; and
a watermark generation module, coupled to the watermark recovery module, that generates a watermarked video signal in accordance with the recovered watermark data.

2. The watermarking module of claim 1 further comprising:
a watermark data module, coupled to watermark generation module, that generates original watermark data based on non-watermark data that is based on the video signal, and the watermark generation module generates the watermarked video signal in accordance with both the original watermark data and recovered watermark data.

3. The watermarking module of claim 2 wherein the non-watermark data includes content control information recovered from one of, a video blanking interval of the video signal and digital data included in the video signal.

4. The watermarking module of claim 2 wherein the non-watermark data includes parental rating information recovered from one of, a video blanking interval of the video signal and digital data included in the video signal.

5. The watermarking module of claim 2 wherein the non-watermark data includes parental rating information received from a V-chip in response to the video signal.

6. The watermarking module of claim 2 wherein the non-watermark data includes closed captioning information recovered from one of, a video blanking interval of the video signal and digital data included in the video signal.

7. A watermarking module of claim 2 wherein the watermark data module further generates original watermark data that includes a codeword associated with a scrambling of content included in the video signal, and the watermark generation module generates the watermarked video signal in accordance with both the original watermark data and recovered watermark data.

8. The watermarking module of claim 7 wherein the scrambling of the content included in the video signal includes encrypting the watermarked video signal to form an encrypted video signal and the codeword includes a decryption key for decrypting a portion of encrypted video signal.

9. A video encoding system comprising:
an encoder module that generates an encoded video signal based on a video signal;
a watermarking module, coupled to the encoder module, the watermarking module including:
a watermark data module that generates recovered watermark data based on watermark data from the video signal; and
a watermark generation module, coupled to the watermark data module, that generates a watermarked video signal based on the encoded video signal in accordance with the recovered watermark data.

10. The video encoding system of claim 9 wherein the video signal includes a digital video signal in a first digital video format, the video encoding system further comprising:
a decoder module, coupled to the encoder module, that generates a decoded video signal by decoding the video signal from the first digital video format;
wherein the encoder module generates the encoded video signal in a second digital video format from the decoded video signal.

11. The video encoding system of claim 10 wherein the second digital video format is transcaled from the first digital video format.

12. The video encoding system of claim 10 wherein the second digital video format is transrated from the first digital video format.

13. A video encoding system of claim 9 wherein the watermark data module further generates original watermark data that includes a codeword associated with a scrambling of content included in the video signal, and the watermark generation module generates the watermarked video signal in accordance with both the original watermark data and recovered watermark data.

14. The video encoding system of claim 18 wherein the scrambling of the content included in the video signal includes encrypting the watermarked video signal to form an encrypted video signal and the codeword includes a decryption key for decrypting a portion of encrypted video signal.

15. A method comprising:
generating an encoded video signal based on a video signal;
generating recovered watermark data based on watermark data from the video signal; and
generating a watermarked video signal based on the encoded video signal in accordance with the recovered watermark data.

16. The method of claim 15 wherein the video signal includes a digital video signal in a first digital video format, the method further comprising:
generating a decoded video signal by decoding the video signal from the first digital video format;
wherein generating the encoded video signal generates the encoded video signal in a second digital video format from the decoded video signal.

17. The method of claim 16 wherein the second digital video format is transcaled from the first digital video format.

18. The method of claim 16 wherein the second digital video format is transrated from the first digital video format.
